(19) United States
(12) Patent Application Publication
(10) Pub. No.: US 2023/0045045 A1
(43) Pub. Date: Feb. 9, 2023

(54) Bluetooth Power Charger

(71) Applicant: Canard McCalpine, Northport, AL (US)

(72) Inventor: Canard McCalpine, Northport, AL (US)

(21) Appl. No.: 17/397,885

(22) Filed: Aug. 9, 2021

(51) Int. Cl. H02J 50/23; H02J 50/27; H02J 7/02

(52) U.S. Cl. CPC H02J 50/23; H02J 50/27; H02J 7/02; H02J 2310/12; H02J 2207/20

(57) ABSTRACT

The disclosure is the only product of its kind that utilizes a Bluetooth connectivity to generate and transfer power from power outlets into other devices to support their performance. The disclosure is uniquely designed in two different sizes, one to activate TV's or gaming consoles and a slightly larger pod for larger electronic gadgets. Both charging pods utilize an advanced power aggregation technology and are highly portable and simple to use to guarantee practicality and versatility. A wireless transceiver housed in the wall plug or pod transmits an electrical power across a carrier frequency and a frequency converter housed in the wall plug and configured to convert the carrier frequency to a predetermined AC (alternating current) frequency at a predetermined AC voltage, Multiple electrical milliwatt power sources as disclosed each wirelessly transmit to a receiver for an aggregated wattage power reception.

### BACKGROUND

As the world becomes increasingly reliant and influenced by electronic and on-line lifestyles, it is essential that our devices remain connected and fully operational at all times. Ensuring connectivity and functionality of such devices, however, can be difficult considering most electronics require users to plug the device into a power outlet to enable operation. This in return creates a frustrating situation for individuals around the globe as it can be difficult to use the device if the location of the wall socket where the device is plugged in is out of reach. Although extension cords can be used to extend length access, cords often get tangled, damaged and are not long enough thus creating an inconvenient situation for users, There have been no products available as original equipment or as an aftermarket to address this problem.

An apparatus to simplify the process of connecting your electronic devices to power, especially when out of reach of extension cords. There have been no products available as original equipment or as an aftermarket to address this problem either.

There exists need for a device such as the Bluetooth Power charger that is not being met by any known or disclosed device or system of present.

### SUMMARY OF THE INVENTION

The main purpose of the Bluetooth Power Charger is to provide users with a portable outlet charger that sends frequencies through Bluetooth to power other neighboring devices, An electrical power source includes a wireless wall plug comprising conduction prongs and a housing pod, a wireless transceiver housed in the wall plug and configured to transmit an electrical power across a carrier frequency and a frequency converter housed in the wall plug and configured to convert the carrier frequency to a predetermined AC (alternating current) frequency at a predetermined AC voltage. Multiple electrical milliwatt power sources as disclosed each wirelessly transmit to a receiver for an aggregated wattage power reception.

### BRIEF DESCRIPTION OF THE DRAWINGS

FIG. 1 is a front perspective view of the Bluetooth Power Charger in accordance with an embodiment of the present disclosure.

FIG. 2 is a back perspective view of the Bluetooth Power Charger in accordance with an embodiment of the present disclosure.

FIG. 3 is a front perspective view of the Bluetooth Power Charger in accordance with an embodiment of the present disclosure.

FIG. 4 is a back perspective view of the Bluetooth Power Charger in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

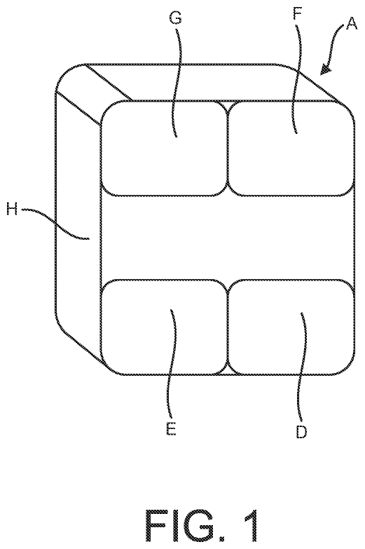

FIG. 1 is a front perspective view of the Bluetooth Power Charger showing: Portable outlet charger via Bluetooth referenced as A., in accordance with an embodiment of the present disclosure. The view also includes a transceiver on a transceiver face D, a frequency converter E, an AC to Direct Current DC converter F, a programmable circuit G and transceiver sides H.

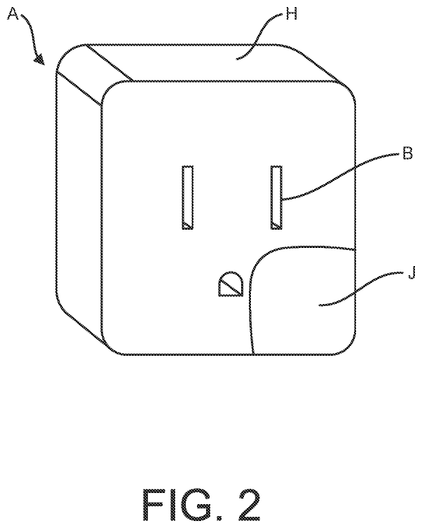

FIG. 2 is a back perspective view of the Bluetooth Power Charger showing: Portable outlet charger via Bluetooth referenced as A., plug-in referenced as B., in accordance with an embodiment of the present disclosure. The view also includes a power aggregation circuit J and transceiver sides H.

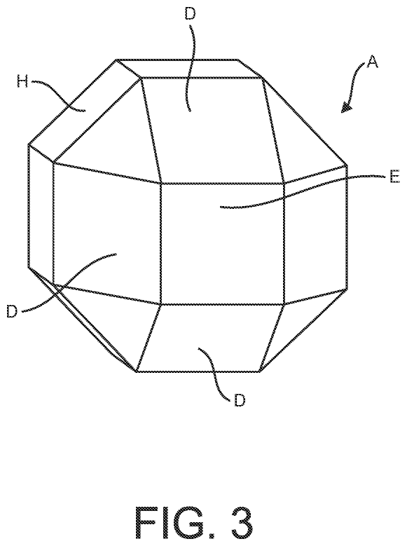

FIG. 3 is a front perspective view of the Bluetooth Power Charger showing: Portable outlet charger via Bluetooth referenced as A., in accordance with an embodiment of the present disclosure. The view also includes a transceiver on transceiver faces D and a frequency converter E.

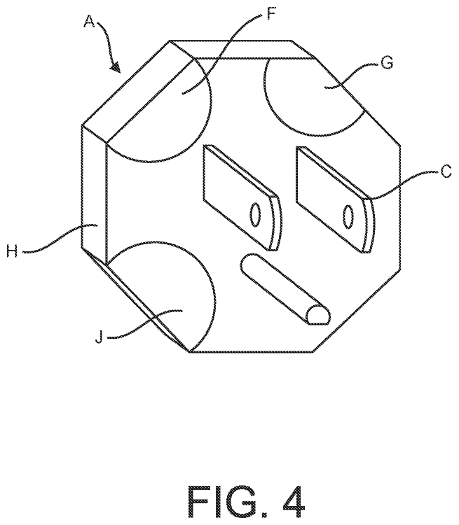

FIG. 4 is a back perspective view of the Bluetooth Power Charger showing: Portable outlet charger via Bluetooth referenced as A., plug-in referenced as B., in accordance with an embodiment of the present disclosure. The view also includes an AC to Direct Current DC converter F, a programmable circuit G and transceiver sides and an aggregation circuit J.

The present disclosed Bluetooth. Power Charger, also known as “Household Product”, enables users to power their devices through a Bluetooth connection and therefore eliminates the need for users to physically plug devices into a wall socket. Expanding on the initial design of a charger, the Household Product introduces a novel portable outlet charger pod that connects to any desired device in order to source generated power. Once the charger is plugged into the socket, energy travels through the pod with the Bluetooth connection to power the connected device. The Bluetooth range and power covers a widespread area which in return allows users to utilize and turn on their electronics from far locations without the use or restriction of standard extension cords. The Household Product ensures a highly functional electronic device activation system without any cords thus creating a less cluttered and more convenient option for users.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An electrical power source comprising:
a wireless wall plug comprising conduction prongs and a housing pod;
a wireless transceiver housed in the wall plug and configured to transmit an electrical power across a carrier frequency;
a frequency converter housed in the wall plug and configured to convert the carrier frequency to a predetermined AC (alternating current) frequency at a predetermined AC voltage.

2. The electrical power source of claim 1, wherein the carrier frequency includes a centerband frequency of 2.4 GHz.

3. The electrical power source of claim 1, further comprising an electrical socket receiver in a side of the housing pod and configured to transmit the electrical power source.

4. The electrical power source of claim 1, wherein the predetermined AC frequency is 60 Hertz and the predetermined AC voltage is 120 volts.

5. The electrical power source of claim 1, wherein the carrier frequency is a long wave frequency configured to non-invasively pass through living tissue.

6. The electrical power source of claim 1, wherein the carrier frequency is a radio wave frequency configured to non-invasively pas through living tissue.

7. The electrical power source of claim 1, wherein the carrier frequency is an X ray frequency configured to non-invasively pass through living tissue.

8. The electrical power source of claim 1, wherein the wireless transceiver comprises eight sides for an octagonal transmission and reception direction.

9. The electrical power source of claim 1, wherein the wireless transceiver comprises nine faces for a nine directional transmission and reception.

10. The electrical power source of claim 1, Wherein the frequency converter is housed in a receiver charging pod.

11. The electrical power source of claim 1, wherein the predetermined AC frequency and AC voltage is respectively 50 hertz and 230 volts.

12. The electrical power source of claim 1, wherein the predetermined AC frequency and AC voltage is respectively 60 hertz and 240 volts.

13. The electrical power source of claim 1, further comprising a second frequency converter housed in a receiver charging pod.

14. The electrical power source of claim 1, further comprising an AC to direct current (DC) power converter housed in a receiver charging pod for powering DC devices.

15. The electrical power source of claim 1, wherein the predetermined AC frequency and AC voltage are programmable via a programmable circuit housed inside the housing pod.

16. The electrical power source of claim 1, wherein the transceiver comprises a transmitter circuit coupled with a receiver circuit.

17. The electrical power source of claim 1, wherein a first electrical power source acts as a transmitter of AC power and a second power source acts as a receiver of the AC power.

18. The electrical power source of claim 1, wherein a plurality of 2.4 GHz electrical power sources each act as a portioned transmitter to a single receiver for an aggregated power.

19. The electrical power source of claim 1, wherein a plurality of electrical power sources each act as a wireless contributor to an aggregated power having guard bands on a maximum aggregated power received at another electrical power source.

20. The electrical power source of claim 1, wherein a plurality of electrical milliwatt power sources each wirelessly transmit to a receiver for an aggregated wattage power reception.
